(19) United States
(12) Patent Application Publication
(10) Pub. No.: US 2010/0328235 A1
(43) Pub. Date: Dec. 30, 2010

(54) Medical Code Lookup Interface

(76) Inventor: Frederick Charles Taute, Marietta, GA (US)

Correspondence Address: Jones IP Law, LLC, P.O.Box 672646, Marietta, GA, 30006, US

(21) Appl. No.: 12/566,784

(22) Filed: Sep. 25, 2009

Related U.S. Application Data
(60) Provisional application No. 61/221,381, filed on Jun. 29, 2009.

(51) Int. Cl. G06F 3/048; G06F 3/041; G10L 21/00

(52) U.S. Cl. 345/173; 704/275; 715/771; 704/E21.001

(57) ABSTRACT

Systems and methods for displaying a graphical user interface within a medical system for medical code lookup, comprising: (1) a first layer displaying at least one anatomical image for selecting at least one anatomical part and display of another layer, and layer selection regions for display of another layer; (2) a second layer displaying a secondary anatomical image including either a selectable cross section image, a selectable contents type image, a three dimensional image, or selectable regions similar to buttons; (3) a third layer displaying selectable classification regions corresponding to a classification group of medical codes relevant to selected sections from the secondary anatomical image; (4) a fourth layer displaying a results code set for selected classification regions, including selectable medical codes from each respective classification group; (5) navigation regions to display other layers; and (6) a medical codes display region for displaying selected codes from the results code set.

### CROSS-REFERENCE TO RELATED APPLICATIONS

This application claims benefit under 35 U.S.C. §119(e) of U.S. Provisional Patent Application Ser. No. 61/221,381, entitled “Methods and Systems for Diagnosis and Medical Service Code Lookup, Including ICD Codes, by Body Part and Service Type or Etiology using a Computerized Image Driven User Interface,” filed Jun. 29, 2009, which is incorporated herein by reference as if set forth herein in its entirety.

### TECHNICAL FIELD

The present invention relates generally to medical codes used by medical professionals for the classification of diseases and related health problems, and more particularly to a graphical user interface for providing lookup of diagnosis codes and medical service codes to medical systems.

### BACKGROUND

Medical codes typically include such codes as medical diagnosis codes and medical service or procedure codes that are used to identify specific medical diagnosis performed by and/or interventions taken by medical professionals. To effectively treat patients and/or perform administrative tasks such as billing, healthcare providers often require access to these medical codes.

Medical codes currently used within the United States, for example, are varied and include such codes as the American Medical Association (AMA) copyrighted Current Procedure Terminology (CPT) codes, the Healthcare Common Procedure Coding System (HCPCS) codes maintained by Medicare, anesthesia codes, dental codes, and many other proprietary code sets, such as those used by workers compensation boards, for example. One commonality of these code sets is a series of alphanumeric codes with descriptions, and they are often divided into sections and subsections by service classification, body region or body part.

Medical diagnosis codes are based on standardized code sets that are maintained at the national and international level. For example, the International Classification of Diseases, Ninth Revision, Clinical Modification (ICD-9-CM) is based on the World Health Organization's Ninth Revision, International Classification of Diseases (ICD-9). This code set is currently used for medical transactions in the United States.

The National Center for Health Statistics (NCHS) is the Federal agency responsible for use of the International Statistical Classification of Diseases and Related Health Problems, 10th revision (ICD-10) in the United States, and has developed a clinical modification of the classification for morbidity purposes. The ICD-10 code set is used to code and classify mortality data from death certificates, having replaced ICD-9 for this purpose as of Jan. 1, 1999.

The ICD-10 code set is copyrighted by the World Health Organization (WHO), which owns and publishes the classification. WHO has authorized the development of an adaptation of ICD-10 for use in the United States for U.S. government purposes. The ICD-10-CM code set is planned as the replacement for ICD-9-CM, volumes 1 and 2 in October 2013.

The current ICD-9 code set consists of an alphanumeric code having between 3 and 5 characters and a description, and currently comprises approximately 16,000 codes. ICD-10 may contain on the order of 80,000 codes.

Current methods of code lookup use variations of text search, or a navigation of the code structure using the standard chapter headings of the particular code set. This invariably leads to difficulty, as the descriptions in the code set being searched often contain abbreviations and/or different wording than the search term—for example “neck” vs. “cervical”. It is also possible that the search terms being entered can find one of a sub-group of codes, but exclude others in the sub-group which in fact may be more appropriate, as the wording in the descriptions can often vary amongst the same sub-group.

Such an environment often makes it necessary for the individual doing the search to become a coding expert to have any proficiency at searching for medical codes. In addition, entering search terms can be time consuming, especially if the functionality is being accessed on a handheld portable device or some other touch screen device.

Thus, there is a need for a more user-friendly and functional mechanism for searching for and verifying medical codes.

### SUMMARY

Briefly described, and according to one embodiment, the present invention is directed towards a graphical user interface for display of layer display regions on a display device within a medical system configured for medical code lookup, the graphical user interface comprising: (1) a first layer display region to display at least one anatomical image on the display device, wherein each anatomical image includes a plurality of selectable anatomical part regions, and to display a plurality of layer selection regions, wherein display of a corresponding layer display region is dependent upon: (a) selection of at least one anatomical part, and (b) selection of a layer selection region, (2) a second layer display region to display a secondary anatomical image, wherein the secondary anatomical image displayed is dependent upon at least one selection from the first layer display region, and wherein the secondary anatomical image includes at least one of (a) a cross section image that includes selectable regions of each selected anatomical part region, (b) a contents type image that includes a selectable frontal view, (c) a three dimensional image with selectable regions and (d) selectable regions having a visual appearance similar to a button, (3) a third layer display region to display a plurality of selectable classification regions, wherein each classification region corresponds to a classification group of medical codes that is relevant to at least one of: (a) selected sections from a respective selected anatomical part region, and (b) a respective selected layer region, (4) a fourth layer display region to display a results code set upon selection of at least one classification region, wherein the results code set includes medical codes from each respective classification group that corresponds to each selected classification region, and wherein each medical code in the results code set is selectable, (5) a plurality of navigation regions operable to cause display of a corresponding layer display region, and (6) a medical code display region operable to display at least one selected code from the results code set.

In some embodiments, the first layer diagram further comprises at least one multiple-selection region operable for selecting additional anatomical part regions.

In another embodiment, an all-selection region provides for selecting every anatomical part region from the anatomical image.

In another embodiment, the number of layer selection regions and their corresponding layout correspond to the particular medical codes in use.

In some embodiments, the medical codes include at least one of medical procedure codes, medical diagnosis codes, disease classification codes, health related problem codes, mental health codes, anesthesia codes, pharmaceutical codes, topographical codes and dental codes.

In some embodiments, the layer selection regions are applicable for medical diagnosis codes and include at least one of obstetrical functionality, psychiatric functionality, endocrine functionality, external injury functionality and supplemental functionality.

In some embodiments, one layer selection region corresponds to obstetrical functionality for navigation to the second layer display region, and the second layer display region displays an image of a selectable pregnant female abdomen image.

In other embodiments, the selectable classification groups include at least one of psychiatric illness, etiology, external injury cause and supplemental.

Other embodiments provide navigation regions operable for navigation to the first layer diagram, navigation to a previous layer display region, navigation to a next layer display region and navigation to the fourth layer display region.

In another embodiment, the graphical user interface includes at least one user input selection device.

In another embodiment, the graphical user interface includes a touch screen for receiving input and for displaying each layer display region.

In another embodiment, touch screen is operable for a hand-held device.

In another embodiment, the hand-held device comprises at least one button external to the touch screen device to provide input for selection for at least one of layer display region, navigation region, layer selection region, anatomical part region, at least one section of anatomical part region, classification region, at least one medical code from the results code set and medical code display region.

In another embodiment, a voice input interface is included for receiving voice signals for selection of at least one of layer display region, navigation region, layer selection region, anatomical part region, at least one section of anatomical part region, classification region, at least one medical code from the results code set and medical code display region.

In another embodiment, a refinement display region is included for receiving text input to refine medical codes with smart search functionality.

In another embodiment, an output display region is included (1) to copy selected codes to a clipboard interface, or (2) to forward selected codes to another system.

In another embodiment, at least one selectable region of each layer display region has a visual appearance similar to a button.

In another embodiment, the visual appearance of each selectable region is similar to an icon.

Yet another embodiment provides a method for displaying a graphical user interface for medical code lookup on a display device within a medical system, the method comprising: (1) displaying a first layer display region to include: at least one anatomical image for selection of at least one anatomical part region and subsequent display of a corresponding layer display region, and a plurality of layer selection regions, each operable for selection and display of another layer display region; (2) upon selection of at least one anatomical part region from the first layer display region, displaying a second layer display region that includes a secondary anatomical image dependent upon selections from the first layer display region, and wherein the secondary anatomical image includes at least one of (a) a cross section image that includes selectable regions of each selected anatomical part region, (b) a contents type image that includes a selectable frontal view, (c) a three dimensional image with selectable regions and (d) selectable regions having a visual appearance similar to a button, (3) upon selection from the secondary anatomical image, displaying a third layer display region that includes a plurality of selectable classification regions that correspond to a classification group of medical codes that is relevant to selected regions from the secondary anatomical image, (4) upon selection of at least one classification region, displaying a fourth layer display region wherein a results code set includes selectable medical codes from each respective classification group that corresponds to each respective classification region, (5) displaying a plurality of navigation regions within each layer display region, wherein the navigation regions are operable to cause display of a corresponding layer display region and (6) displaying at least one selected code from the results code set to a separate medical code display region.

Still another embodiment provides for a computer-implemented method for displaying a graphical user interface for medical code lookup on a display device within a medical system, the method comprising: (1) computer readable code that causes display of a first layer display region to include (a) at least one anatomical image for selection of at least one anatomical part region and subsequent display of a corresponding layer display region, and (b) a plurality of layer selection regions operable for selection and display of another layer display region, (2) computer readable code that, upon selection of at least one anatomical part region from the first layer display region, causes display of a second layer display region that includes a secondary anatomical image dependent upon selections from the first layer display region, and wherein the secondary anatomical image includes at least one of (a) a cross section image that includes selectable regions of each selected anatomical part region, (b) a contents type image that includes a selectable frontal view, (c) a three dimensional image with selectable regions and (d) selectable regions having a visual appearance similar to a button, (3) computer readable code that, upon selection from the secondary anatomical image, causes display of a third layer display region that includes a plurality of selectable classification regions that correspond to a classification group of medical codes that is relevant to selected regions from the secondary anatomical image, (4) computer readable code that, upon selection of at least one classification region, causes display of a fourth layer display region wherein a results code set includes selectable medical codes from each respective classification group that corresponds to each respective classification region, (5) computer readable code that causes display of a plurality of navigation regions within each layer display region, wherein the navigation regions are operable to cause display of a corresponding layer display region and (6) computer readable code that causes display of at least one selected code from the results code set to a separate medical code display region.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an embodiment of a graphical user interface displaying a first layer with anatomical images according to the present invention.

FIG. 2 is an embodiment illustrating rollover functionality of a first layer of a graphical user interface according to FIG. 1.

FIG. 3A is an embodiment of a graphical user interface displaying a second layer with an anatomical image part according to the present invention.

FIG. 3B is an embodiment of a graphical user interface displaying a second layer with an anatomical image part and including rollover functionality according to the present invention.

FIG. 4 is an embodiment of a graphical user interface displaying a third layer including classification selection regions according to the present invention.

FIG. 5 is an embodiment of a graphical user interface displaying a fourth layer including a results code set according to the present invention.

FIG. 6 is a flow diagram for a graphical user interface according to one embodiment of the present invention.

### DETAILED DESCRIPTION

Reference is now made in detail to the description of the embodiments of systems and methods for a graphical user interface for providing lookup of diagnosis codes and medical service codes to medical systems as illustrated in the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

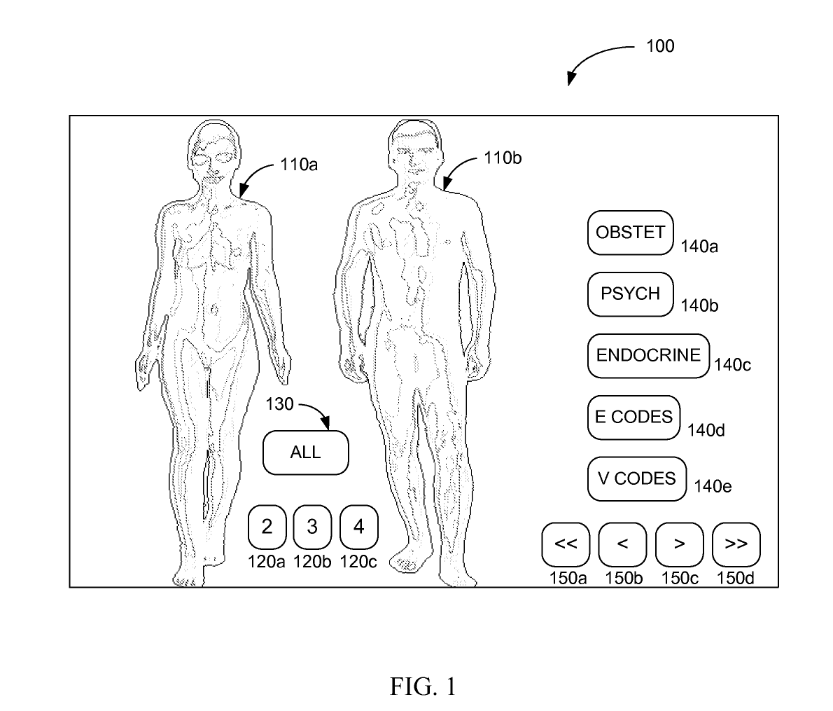

Turning now to the drawings, FIG. 1 is graphical user interface 100 for providing lookup of medical codes for medical computer systems and devices. The graphical user interface 100 is operable for any computer or computer like device that offers a graphical display capable of displaying images and a user interface for selection of the displayed images or portions of the displayed images. One exemplary use for the graphical user interface 100 is a hand-held computer device such as can be used by a doctor or other medical staff performing diagnostics. Such a handheld device would typically provide a touch screen input or a scroll device input. An alternative input for the hand-held device could also be a stylus input, or any other input that is commonly used for hand-held computerized devices. The graphical user interface 100 can also be used in a personal computer system, or any other computer system that provides for a graphical display and an input device for selection of objects on a display device. It should be noted also that the present invention can also be adapted for voice command inputs to the graphical user interface 100.

The graphical user interface 100 allows a user to drill down to a set of medical codes, such as medical procedure codes or medical diagnosis codes, with a few clicks, touches, or even voice commands. In a typical embodiment, there are three selection layers or layer display screens that lead to a fourth and final layer containing an appropriately filtered subset of medical codes. It should be understood that the number of layers is merely a design consideration that can be adapted for more or fewer layers as different type code sets are incorporated within the corresponding medical system.

The graphical user interface 100 is adaptable for a multitude of medical codes, such as medical procedure codes, medical diagnosis codes, disease classification codes, health related problem codes, mental health codes, anesthesia codes, pharmaceutical codes, topographical codes and dental codes, among many others too numerous to mention. Exemplary medical procedure codes include such code sets as the American Medical Association Current Procedural Terminology (CPT) codes, Healthcare Common Procedure Coding System (HCPCS) codes, National Drug Code (NDC) codes, and Nursing Interventions Classification (NIC) codes, among others. Exemplary medical diagnosis codes include such code set as the International Classification of Diseases (ICD-9 and ICD-CM-9), the International Statistical Classification of Diseases and Related Health Problems 10th Revision (ICD-10 and ICD-10-CM), among many others. The present invention is also adaptable for modifications and additions to these codes.

Returning again to FIG. 1, the graphical user interface 100 typically displays two anatomical images 110. A typical anatomical image 110 can include a female image 110a and a male image 110b. The anatomical images 110 are typically full body images depicting a high level view of the various parts for each body. The display shown in FIG. 1 depicts selectable options that are present on the screen for diagnosis code lookup. Each anatomical image 110 includes target regions for selection of a particular body part. (If the user desired to skip to the next layer without selecting a body part, the navigation selection region 150c should be selected as described below.) Additionally, the anatomical image 110 can typically be included within a display frame for selecting the whole body. Also, the anatomical image 110 can be a three dimensional image allowing, for example, rotation of the body for selection of body parts on either side or on the rear side of the body.

To perform a diagnosis code lookup, a user typically selects an anatomical part or a body part from either the female image 110a or the male image 110b by clicking or touching the respective body part or a layer selection region 140 (or diagnosis selection region in this example). The layer selection regions 140 shown include obstetrics 140a, psychiatric 140b, endocrine 140c, E codes 140d and V codes 140e.

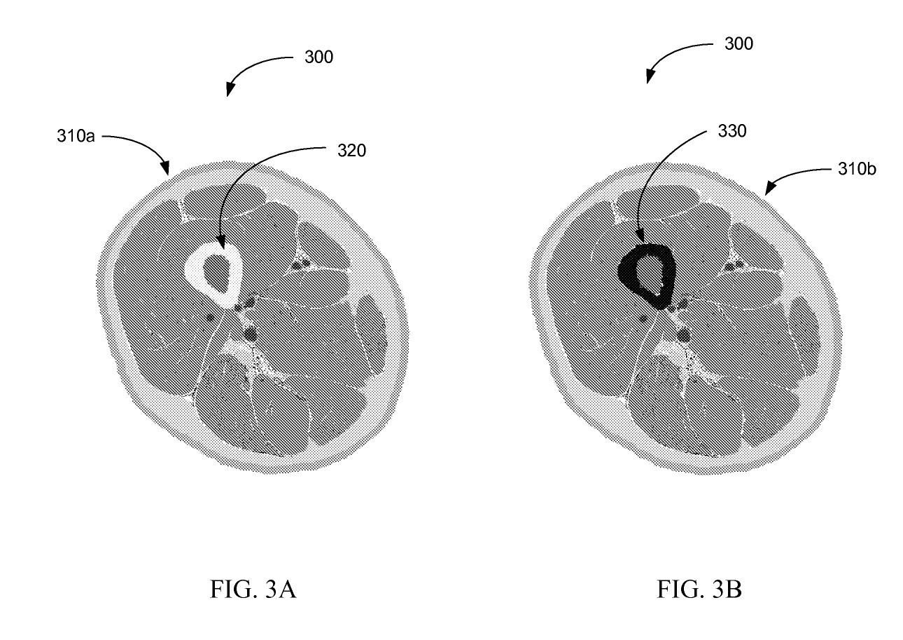

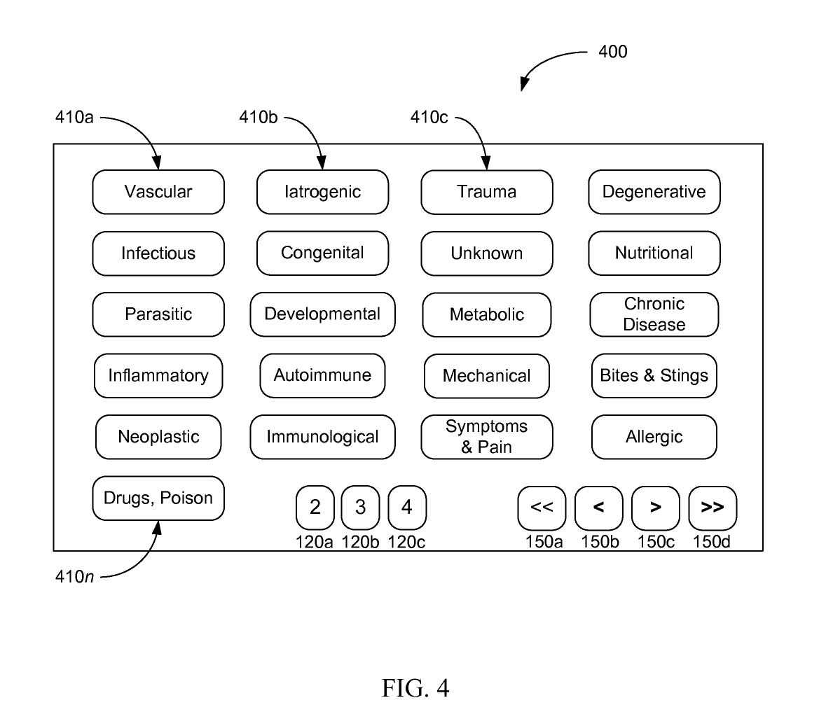

Selecting one of the layer selection regions 140 causes the display to navigate to another layer, depending on which layer selection region 140 is selected. The second layer, see FIG. 3, typically displays a cross section and/or contents type image of the body part (or anatomical part) that was selected. The third layer, see FIG. 4, typically displays classification selection regions representing classifications of medical codes according to the selections made at the first and second layer screens. The fourth layer screen typically displays a filtered set of medical codes within the codes sets that are selected at the third layer screen.

At the first layer screen or display of the graphical user interface 100 for example, selecting obstetrics 140a causes navigation to the second layer screen where an image of a pregnant female abdomen (not shown) is displayed. Selection of the psychiatric 140b layer selection region causes navigation to the third layer screen where psychiatric illness classification groups are displayed. Selection of the endocrine 140c layer selection region also causes navigation to the third layer screen, where in this case selection of an etiology is performed.

For the E codes 140d and V codes 140e where the medical diagnosis codes have no relevance to a body part, selection causes navigation to the third layer screen for selection of classification groups relating to external injuries (automobile accident, skiing accident, etc.) or other supplemental classifications (health status, immunizations, etc.).

It should be noted that the options of selectable layer selection regions 140 displayed at each layer screen is variable and dependent upon the medical code set and/or other codes sets that are being searched, as well as the version of the product that is in use. The graphical user interface 100 is adaptable for providing a search within a single set of codes, such as medical diagnosis codes, but is also capable of combining multiple sets of codes, such as medical diagnosis codes and medical procedure codes, and even more sets of codes simultaneously.

Additionally, it should be noted that the layer selection regions 140, as well as other selection regions, within the present invention are described in this disclosure in a format comparable to buttons displayed on the screen. The display of the selection regions on a screen are not limited to this configuration however, and can be displayed in any fashion that is common for graphical user interfaces to signify selection functionality, such as buttons, icons, text regions, buttons with images, buttons with text, textual descriptions, and the like. Additionally, rollover functionality can be applied to any selection region to further reveal the functionality.

It should be noted also that additional layer selection regions 140 or other selection regions are made available in the event of desired codes that are not applicable to a specific body part, for example.

Additionally, the anatomical images 110 displayed on the first layer screen can be varied according to the medical environment. For example, an OB/GYN practice has no need for displaying a male image, and can thus begin with a full body pregnant female image on the first layer. Alternatively, an OB/GYN can also default to the second layer screen as the starting point and display the cross-section image of a pregnant female body image. Other medical practice groups could similarly default to certain start screens such as a head image for a neurosurgeon, etc.

Additionally, there is capability for selecting multiple body parts from the anatomical image 110 with the multi-selection regions (multi-selection buttons) 120. In the example shown, there is the option for selecting 2, 3 or 4 body parts with multi-selection buttons 120a, 120b and 120c respectively. Prior to selecting the body parts, the user simply selects one of the multi-selection buttons 120 and then selects the corresponding number of body parts from the anatomical image 110. Of course, the number of multi-selection buttons 120 as well as the corresponding number of body parts that can be selected is variable and limited only by design considerations. Additionally, it is within the scope of the graphical user interface to use an input field to receive the number of body parts that can be selected.

Also, the user can select the all-selection button 130 to select all body parts of the respective anatomical image 110. The user is then presented with display screen similar to FIG. 3A below that typically includes both a frontal view and a cross section view for selection of the particular tissue (e.g., skin) or cause involved that affects the whole body. This ‘whole body’ image does not necessarily show the whole body, but rather shows various tissues, bones, etc. that can be affected over the entire body.

Finally, each layer screen includes navigation regions (navigation buttons) 150 for navigating to other layer diagrams within the graphical user interface 100. For example, navigation button 150a causes navigation to return to the first layer diagram. Selecting navigation button 150b causes navigation to the previous layer diagram. Selecting navigation button 150c causes navigation to the next layer screen. The selection of navigation button 150d causes navigation to the final or end layer screen (typically the fourth layer).

If a layer cannot be reached from a present layer, then the corresponding navigation button 150 does not appear on the present layer display.

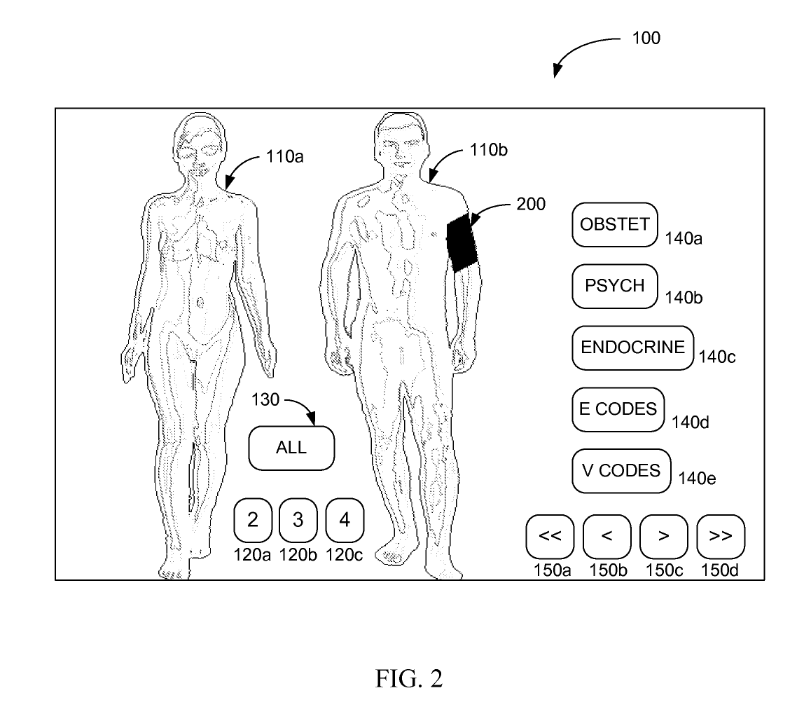

FIG. 2 illustrates the graphical user interface 100 with the visual effect from a rollover 200 of a particular body part. A rollover 200 can also be effected by a mouseover or by touching the screen on a hand-held or other touch screen device. In this example, the diagnosis is an upper arm fracture and the upper arm is highlighted by a rollover 200. Typically, a rollover actually highlights all four of the upper arms in the image, since a full body image 110 has not yet been selected. Alternatively, functionality could be adapted to only highlight one side of the body, such as the upper left arm in this case.

Once the user selects the particular body part or body region (anatomical region), the second layer screen 300 is displayed. In this example, the upper left arm for the male image 110b is selected. The relevant anatomically appropriate image for the selected body part or region is shown in the second layer screen 300. These images may be cross-sectional or contents type images.

FIG. 3A and FIG. 3B depict an embodiment of a typical second layer screen 300 for the graphical user interface 100. A typical second layer screen 300 displays an anatomical image such as a cross section image 310a for the respective body part that has been selected at the first layer of the graphical user interface 100. The selected body part is musculoskeletal and therefore, the cross-section displays an upper arm having selectable regions or portions, such as skin, subcutaneous, muscle, vascular, nerve, bone and bone marrow. Alternatively the anatomical image can be a three dimensional image with selectable regions.

In the event that the body region is a hollow body section, such as the abdomen, the anatomical image displayed in the second layer is a contents type, simplified frontal image, or a three dimensional image of the various organs, along with a cross sectional view depicting skin, subcutaneous muscle, vascular, nerve and bone, along with any deep organs not easily depicted in the frontal image. Thus, the second layer can, in some instances, display both a frontal image and a side image of the selected body part.

For selection of the head, a cross section image is displayed that includes the upper neck, together with regions for the brain, cerebellum, brainstem, cerebral vascular, sinus and nose, mouth and larynx. A button is also typically included for psychiatric disorders.

It should be noted that the nose, eye, mouth and ear are also target regions for the first layer screen as shown in FIG. 1 above.

FIG. 3A displays the cross section image of the upper arm selected from the first layer screen. Since an upper arm fracture is the diagnosis in this example, the user selects the bone 320. FIG. 3B illustrates the rollover effect 330 of the bone 320.

In an alternate embodiment, the graphical user interface 100 is accessed on a computerized device with a small screen. In such an embodiment, the selection process is typically facilitated with a series of selectable color coded buttons. Each selectable color coded button corresponds to one of the seven objects in the upper arm image. Of course, other display images with a different count of objects will have a correspondingly different count of colors from which to select.

Alternatively, selectable alpha coded buttons can also be utilized, such as S for skin, SC for subcutaneous, M for muscle, V for vascular, N for nerve, and the like.

It should be noted also that the multiple-selection buttons 120, the all-selection button 130 and the navigation buttons 150, as displayed in the first layer 100 are also available in the second layer 300, though these buttons are not shown in FIG. 3A or FIG. 3B.

Also, as noted above, the user can select the all-selection button 130 from the first layer screen to select all body parts of the respective anatomical image 110. The user is then presented with display screen similar to FIG. 3A that typically includes both a frontal view and a cross section view for selection of the particular tissue (e.g., skin) or cause involved that affects the whole body. This ‘whole body’ image does not necessarily show the whole body, but rather shows various tissues, bones, etc. that can be affected over the entire body.

FIG. 4 depicts an embodiment of a typical third layer 400 of the graphical user interface 100. The third layer 400 is typically used in the selection of an etiology or service type. The selectable classification regions (buttons) 410 represent medical codes of the classification group (or set) that is being searched, as well as the version of the product (single or multi code set). If the graphical user interface 100 represents a multi code set, additional buttons (selection regions) are made available to allow the selection of an alternative code set.

In the particular example above where the diagnosis is a broken arm, the selectable classification buttons 410 of FIG. 4 are typical of the conditions that could apply based on selection of the upper arm and the bone. A different set of selectable classification buttons 410 appear if the diagnosis were different, for example, related to the abdomen.

It should be noted also, that the selectable classification buttons 410 shown in FIG. 4 are a text based representation, though it should be clear to those of skill in the art that icons or other images, color coding, etc. could be used to represent the various causes, type of problems, or procedures that are relevant to the underlying code set that is queried, and to the selections made at the preceding layers. Only those classification buttons 410 that are relevant to the selections in the previous layers are displayed as active for selection.

Additionally, the multi-selection buttons 120, the all-selection button 130 and the navigation buttons 150 are available at the third layer display. The multi-selection buttons 120 are used for selection of more than one classification button 410.

For example, a user can select multi-selection button 120a for two items, then select foot, then mouth on the full body image 110 of the first layer, select skin at the second layer, and then select infectious to locate the code for foot and mouth disease.

A rollover of one of the selectable classification buttons 410 results in a user tooltip to clarify the functionality of that particular item. The selectable classification buttons 410 shown in FIG. 4 relate to diagnosis code lookup and depict the list of causal factors according to the differential diagnosis mnemonic ‘VINDICATUM’ in addition to several additional categories. The VINDICATUM mnemonic represents the causal factors (1) vascular, (2) inflammatory (3) infectious, (4) neoplastic, (5) drugs, (6) iatrogenic, (7) congenital, (8) autoimmune, (9) trauma, (10) unknown and (11) metabolic. In order to further aid in classification, additional categories have been added including (12) parasitic, (13) developmental, (14) immunological, (15) mechanical, (16) symptoms and pain, (17) degenerative, (18) nutritional, (19) chronic disease, (20) bites and stings and (21) allergic.

In the event that the user has entered the third layer via either the E code or V code lookup button from the first layer, the third layer is dependent on the need for sub-classification of the section that has been selected. As noted above also, the buttons can be either text or icon/images dependent on the suitability that each provides in conveying the meaning to the user.

In some embodiments, an additional subset layer appears between the third layer and the fourth layer where the cause or service type selected at the third layer requires additional categories.

In the above example seeking a diagnosis code for an upper arm fracture, the user selects the classification button for trauma (e.g., image of a hammer) and then the fourth layer is displayed.

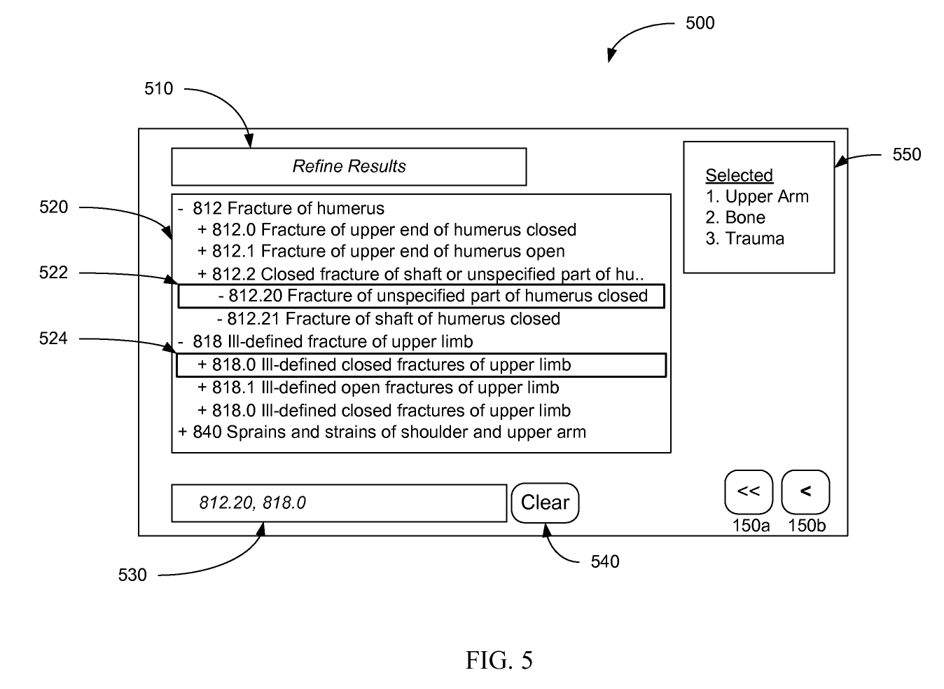

FIG. 5 depicts a typical embodiment of the fourth layer 500 for selecting results from a results code set 520. The results code set 520 typically results from a query corresponding to (1) the selected body part, (2) the tissue or organ and (3) the cause, problem type or procedure as selected in the previous layers.

Additionally, it is possible for the user to arrive at the fourth layer via selection of the end or final navigation button 150d. In this event, the results code set 520 displays the full set of codes. The full set of codes can still be filtered via the refine results 510 text input field which allows for a smart search of the results code set 520.

The results code set 520 typically displays a tree view that displays the underlying code set in logical groups with their respective header codes as applicable depending on the code set being searched. The results code set 520 list, typically filtered, allows the user to easily expand or contract the tree view as a whole or at an individual tree level. Any code in the results code set 520 can be selected or deselected. Selected codes are displayed simultaneously in the selected codes field 530 and are also copied to the device clipboard memory. A clear button 540 allows for resetting the selected codes field 530.

In the example shown, two codes 522, 524 are selected and are therefore displayed in the selected codes field 530.

Additionally, a label region 550 displays the selections that caused the present displayed code sets to be displayed.

In an alternative embodiment, the graphical user interface 100 interfaces with another system, database, etc. and provides capability for sending the results to another system beyond the medical system in which the graphical user interface 100 resides. For example, an additional ‘Send’ button displayed at the fourth layer can send the results to another system, database, or other collection mechanism. In another example, a ‘Copy’ button can copy the results to a clipboard interface for insertion into another program or location.

In another alternative embodiment, selection of a letter or entering a letter in a field, allows for instantly jumping to the results code set 520 items that begin with the corresponding letter.

Navigation buttons 150 are also present for returning to the previous layer or to the first layer. Using the navigation buttons 150 at the fourth layer allow the user to return to the third layer, change the selected code set, and then proceed again to the fourth layer with the upper level filters remaining as previously selected via the body part and tissue selections, for example, in the first and second layers. For example, a user could have previously selected the upper arm, bone and trauma to locate the appropriate medical diagnosis code for a fracture. That same user could then change the third layer to service, select surgical procedure, and locate the appropriate code for surgical treatment of the fracture.

The code lookup interface can also interact with other systems. In one embodiment, the graphical user interface 100 is embedded in other coding, medical record, billing, or related systems. The system is then called at the appropriate time during the workflow within that system (an originating system or application), used for the code lookup, and returns the set of selected codes to the originating application and simultaneously closing the code lookup system.

As noted above, the graphical user interface 100 also provides for voice controlled operation. Verbal commands are provided through voice conversion software on the computerized device or hand-held device. Thus, the code search can still be conducted via the anatomical images in the same drill-down fashion with auditory commands replacing or in addition to touch screen or keystrokes.

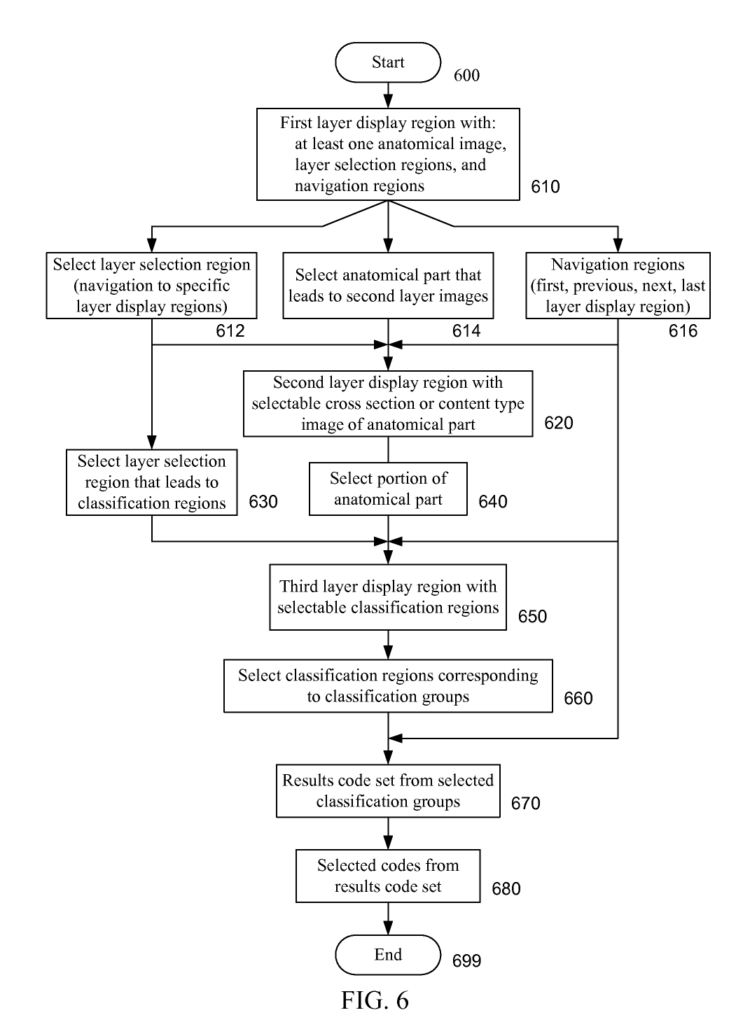

FIG. 6 is a flow diagram 600 depicting operation of the graphical user interface 100 for medical code lookup within a medical system. At step 610 the first layer the first layer display region (screen) is displayed and includes at least one anatomical image, layer selection regions, and navigation regions. The selection process can flow through any of steps 612, 614 and/or 616.

At step 614, a selection is made from the anatomical images. Typically, two anatomical images are provided with one being female and the other male. Each anatomical image is selectable so that the user can select at least one body part from the anatomical image.

At step 612, a selection is made from the layer buttons (layer selection regions). The layer buttons can represent diagnosis codes, procedure codes, or any other type codes suitable for medical code lookup, and are operable for selection and display of other layer display screens. After selection of a layer button, control is transferred to the appropriate layer display screen.

At step 616, a selection is made from the navigation regions, which are selectable for proceeding to another layer. This step is typically performed without prior selection of a body part. When the navigation buttons are used, it is typically used instead of the other selection methods of the first layer screen. Use of the navigation buttons transfer control directly to either the second, third or fourth layer screen displays.

At step 620, the second layer screen is displayed as a result of the selection least one anatomical part (body part) or layer selection region from the first layer screen. The second layer screen includes selectable portions of each selected anatomical part. In the event that this screen is selected from the navigation regions, it would display selectable portions of a set of images denoting tissue types.

At step 630, a layer selection region is selected from the first layer screen and control is transferred to the classification regions of the third layer screen.

At step 640, the user typically selects a portion of an anatomical part (body part). Multiple portions of a body part may be selected. Additionally, multiple portions of multiple body parts may be selected.

At step 650, the third layer is displayed depicting selectable classification regions (classification buttons) that correspond to classification groups of medical codes that are relevant to each selected portion from the respective selected body part.

At step 660, classification regions are selected and at step 670, the fourth layer screen is displayed presenting a result code set that includes medical codes from each classification group that corresponds to each respective selected code set button or image.

At step 680, the selected codes from the result code set are displayed.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A graphical user interface for display of at least one layer display region on a display device within a medical system, wherein the medical system is configured for medical code lookup, the graphical user interface comprising:
a first layer display region configured to display at least one anatomical image on the display device, wherein each anatomical image includes a plurality of selectable anatomical part regions, and to display a plurality of layer selection regions, wherein display of a corresponding layer display region is dependent upon at least one of the following:
selection of at least one anatomical part region; and
selection of a layer selection region;
a second layer display region configured to display a secondary anatomical image, wherein the secondary anatomical image displayed is dependent upon at least one selection from the first layer display region, and wherein the secondary anatomical image includes at least one of the following:
a cross section image that includes selectable regions of each selected anatomical part region;
a contents type image that includes a selectable frontal view;
a three dimensional image with selectable regions; and
selectable regions having a visual appearance similar to a button;
a third layer display region configured to display a plurality of selectable classification regions, wherein each classification region corresponds to a classification group of medical codes that is relevant to at least one of the following:
selected sections from a respective selected anatomical part region; and
a respective selected layer region;
a fourth layer display region configured to display a results code set upon selection of at least one classification region, wherein the results code set includes medical codes from each respective classification group that corresponds to each selected classification region, and wherein each medical code in the results code set is selectable;
a plurality of navigation regions, each operable to cause display of a corresponding layer display region; and
a medical code display region within the fourth layer display region, the code display region operable to display at least one selected code from the results code set.

2. The graphical user interface of claim 1, wherein the first layer diagram further comprises at least one multiple-selection region operable for selecting at least one additional anatomical part region.

3. The graphical user interface of claim 2, further comprising an all-selection region operable for selecting every anatomical part region from the anatomical image.

4. The graphical user interface of claim 1, wherein the number of layer selection regions and corresponding layout of the layer selection regions within the first layer display region correspond to the particular medical codes in use.

5. The graphical user interface of claim 1, wherein the medical codes include at least one of the following:
medical procedure codes;
medical diagnosis codes;
disease classification codes;
health related problem codes;
mental health codes;
anesthesia codes;
pharmaceutical codes;
topographical codes; and
dental codes.

6. The graphical user interface of claim 5, wherein layer selection regions are applicable for medical diagnosis codes and include at least one of:
obstetrical functionality;
psychiatric functionality;
endocrine functionality;
external injury functionality; and
supplemental functionality.

7. The graphical user interface of claim 6, wherein one layer selection region corresponds to obstetrical functionality and is operable for navigation to the second layer display region, and wherein the second layer display region displays an image of a selectable pregnant female abdomen image.

8. The graphical user interface of claim 5, wherein the plurality of selectable classification groups include at least one of the following:
psychiatric illness;
etiology;
external injury cause; and
supplemental.

9. The graphical user interface of claim 1, wherein the plurality of navigation regions include navigation regions operable upon selection for:
navigation to the first layer diagram;
navigation to a previous layer display region;
navigation to a next layer display region; and
navigation to the fourth layer display region.

10. The graphical user interface of claim 1, further comprising at least one user input selection device.

11. The graphical user interface of claim 1, further comprising a touch screen operable for receiving input and for displaying each layer display region.

12. The graphical user interface of claim 11, wherein the touch screen is operable for a hand-held device.

13. The graphical user interface of claim 12 further comprising at least one button external to the touch screen, and operable to provide input for selection for at least one of the following:
layer display region;
navigation region;
layer selection region;
anatomical part region;
at least one section of anatomical part region;
classification region;
at least one medical code from the results code set; and
medical code display region.

14. The graphical user interface of claim 10, wherein the user input selection device includes a voice input interface for receiving voice signals for selection of at least one of the following:
layer display region;
navigation region;
layer selection region;
anatomical part region;
at least one section of anatomical part region;
classification region;
at least one medical code from the results code set; and
medical code display region.

15. The graphical user interface of claim 1, further comprising a refinement display region operable for receiving text input to refine medical codes with smart search functionality.

16. The graphical user interface of claim 1, further comprising an output display region operable for at least one of the following:
to copy selected codes to a clipboard interface; and
to forward selected codes to another system.

17. The graphical user interface of claim 1, wherein at least one selectable region of each layer display region has a visual appearance similar to a button.

18. The graphical user interface of claim 17, wherein the visual appearance of each selectable region is similar to an icon.

19. A method for displaying a graphical user interface for medical code lookup on a display device within a medical system, the method comprising:
displaying a first layer display region to include:
at least one anatomical image for selection of at least one anatomical part region and subsequent display of a corresponding layer display region;
a plurality of layer selection regions operable for selection and display of another layer display region;
upon selection of at least one anatomical part region from the first layer display region, displaying a second layer display region that includes a secondary anatomical image dependent upon selections from the first layer display region, and wherein the secondary anatomical image includes at least one of the following:
a cross section image that includes selectable regions of each selected anatomical part region;
a contents type image that includes a selectable frontal view;
a three dimensional image with selectable regions; and
selectable regions having a visual appearance similar to a button;
upon selection from the secondary anatomical image, displaying a third layer display region that includes a plurality of selectable classification regions that correspond to a classification group of medical codes that is relevant to selected regions from the secondary anatomical image;
upon selection of at least one classification region, displaying a fourth layer display region wherein a results code set includes selectable medical codes from each respective classification group that corresponds to each respective classification region;
displaying a plurality of navigation regions within each layer display region, wherein the navigation regions are operable to cause display of a corresponding layer display region; and
displaying at least one selected code from the results code set to a separate medical code display region.

20. A computer-implemented method for displaying a graphical user interface for medical code lookup on a display device within a medical system, the method comprising:
computer readable code that causes display of a first layer display region to include:
at least one anatomical image for selection of at least one anatomical part region and subsequent display of a corresponding layer display region;
a plurality of layer selection regions operable for selection and display of another layer display region;
computer readable code that, upon selection of at least one anatomical part region from the first layer display region, causes display of a second layer display region that includes a secondary anatomical image dependent upon selections from the first layer display region, and wherein the secondary anatomical image includes at least one of the following:
a cross section image that includes selectable regions of each selected anatomical part region; and
a contents type image that includes a selectable frontal view;
a three dimensional image with selectable regions; and
selectable regions having a visual appearance similar to a button;
computer readable code that, upon selection from the secondary anatomical image, causes display of a third layer display region that includes a plurality of selectable classification regions that correspond to a classification group of medical codes that is relevant to selected regions from the secondary anatomical image;
computer readable code that, upon selection of at least one classification region, causes display of a fourth layer display region wherein a results code set includes selectable medical codes from each respective classification group that corresponds to each respective classification region;
computer readable code that causes display of a plurality of navigation regions within each layer display region, wherein the navigation regions are operable to cause display of a corresponding layer display region; and
computer readable code that causes display of at least one selected code from the results code set to a separate medical code display region.
